(19) United States
(12) Patent Application Publication
(10) Pub. No.: US 2025/0254428 A1
(43) Pub. Date: Aug. 7, 2025

(54) IMAGING DEVICE

(71) Applicant: NIDEC PRECISION CORPORATION, Tokyo (JP)

(72) Inventor: Shigemi TAKAHASHI, Tokyo (JP)

(21) Appl. No.: 19/019,469

(22) Filed: Jan. 14, 2025

(30) Foreign Application Priority Data
Feb. 6, 2024 (JP) 2024-016638

(51) Int. Cl. H04N 23/68; H04N 23/695

(52) U.S. Cl. CPC H04N 23/685; H04N 23/6812; H04N 23/695

(57) ABSTRACT

An imaging device includes a base, a housing fixed on the base, a first rotary driver that rotates the base about a base rotational axis, an imaging unit accommodated in the housing and including an image sensor, a connector connecting the imaging unit to the housing to allow the imaging unit to rotate about at least a first unit rotational axis in the housing, and a drive that moves the imaging unit in the housing.

### RELATED APPLICATIONS

The present application claims priority to Japanese Application Number 2024-016638, filed Feb. 6, 2024, the disclosure of which is hereby incorporated by reference herein in its entirety.

### BACKGROUND

### Technical Field

The present invention relates to an imaging device.

### Description of the Background

A known camera can change the orientation of its imaging unit horizontally (panning) or vertically (tilting) (refer to, for example, Patent Literature 1). In recent years, cameras used particularly in meetings or presentations, or cameras used for security are often expected to pan and tilt to follow the target subjects for imaging and to switch the target subjects for imaging. To achieve such panning and tilting, a stepping motor is typically driven to rotate the imaging unit.

### CITATION LIST

### Patent Literature

Patent Literature 1: Japanese Patent No. 4521941

### BRIEF SUMMARY

However, when such a stepping motor starts or ends the operation, backlash resulting from the resolution and the detent torque of the stepping motor may cause vibration. This may cause fluctuations in images when panning or tilting starts or ends, thus blurring the images.

In response to the above issue, one or more aspects of the present invention are directed to an imaging device that can reduce the likelihood of images being blurred when the orientation of an imaging unit is changed.

An imaging device according to one aspect of the present invention can reduce the likelihood of images being blurred when the orientation of an imaging unit is changed. The imaging device includes a base, a housing fixed on the base, a first rotary driver that rotates the base about a first base rotational axis, an imaging unit accommodated in the housing and including an image sensor, a connector connecting the imaging unit to the housing to allow the imaging unit to rotate about at least a first unit rotational axis in the housing, and a drive that moves the imaging unit in the housing.

The imaging device according to the above aspect of the present invention allows the imaging unit to rotate about the first unit rotational axis relative to the housing to counteract any displacement of the imaging unit in the housing caused by a change in the orientation of the imaging unit. Images captured by the imaging unit are thus less likely to be blurred.

### BRIEF DESCRIPTION OF DRAWINGS

FIG. 1 is a schematic plan view of an imaging device according to one embodiment of the present invention.

FIG. 2 is a schematic front view of the imaging device shown in FIG. 1.

FIG. 3 is a schematic partial cross-sectional plan view of a housing in the imaging device shown in FIG. 2, showing its internal structure.

### DETAILED DESCRIPTION

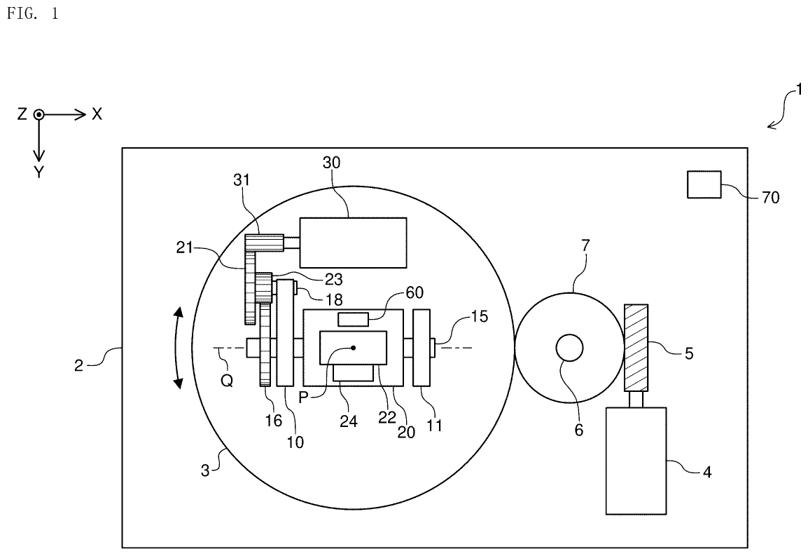

An imaging device according to one or more embodiments of the present invention will now be described in detail with reference to FIGS. 1 to 3. In FIGS. 1 to 3, like reference numerals denote like or corresponding components. Such components will not be described repeatedly. In FIGS. 1 to 3, the scale and dimensions of each component may be exaggerated, or one or more components may not be shown. Unless otherwise specified, the terms such as first and second will be used simply to distinguish the components and will not represent a specific order or sequence.

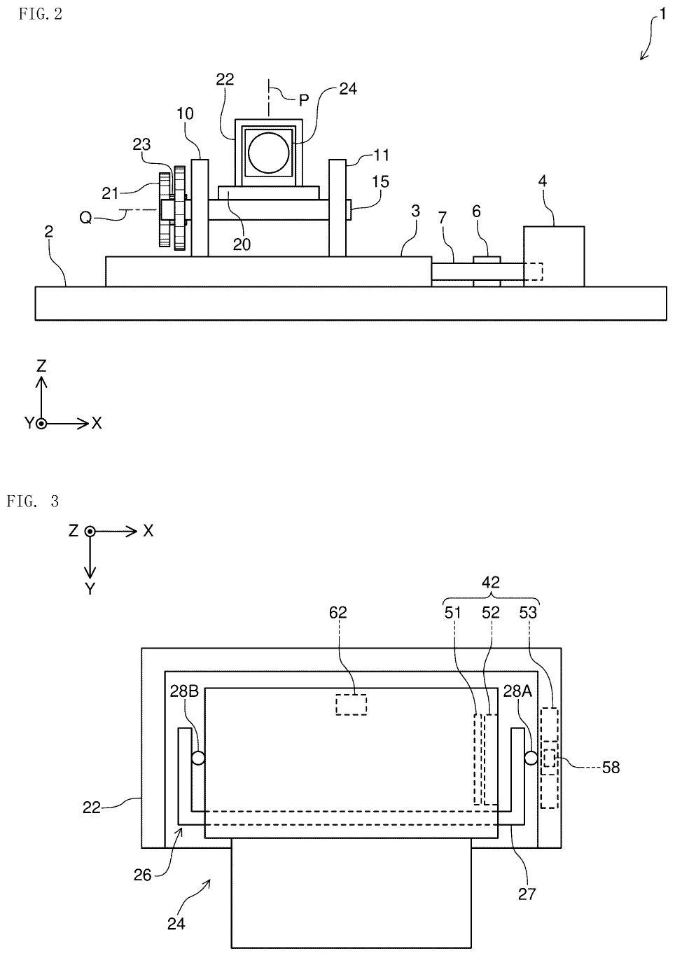

FIG. 1 is a schematic plan view of an imaging device 1 according to one embodiment of the present invention. FIG. 2 is a schematic front view of the imaging device 1. As shown in FIGS. 1 and 2, the imaging device 1 includes a base plate 2, a rotary stage 3 located on the base plate 2 in a manner rotatable about an axis P, and a stepping motor 4 that rotates the rotary stage 3. A worm gear 5 is attached to the rotational shaft of the stepping motor 4. A rotator 7 rotatable about a shaft 6 is mounted on the base plate 2. The rotary stage 3 and the rotator 7 include gears (not shown) on their outer circumferences. The gears on the rotary stage 3 and the gears on the rotator 7 mesh with each other. The gears on the rotator 7 also mesh with gears on the worm gear 5. The rotary stage 3 thus rotates about the axis P as indicated by the arrow in FIG. 1 through the worm gear 5 and the rotator 7 as the stepping motor 4 is driven.

As shown in FIG. 2, a pair of support walls 10 and 11 extend from the rotary stage 3 in the positive Z-direction. The support walls 10 and 11 each have a shaft hole (not shown) through which a shaft 15 extends in the X-direction. The shaft 15 is rotatable relative to the support walls 10 and 11. The support wall 10 has another shaft hole through which a shaft 18 extends in the X-direction. A double gear including two gears 21 and 23 is attached to the shaft 18.

A rectangular plate-like base 20 is attached to the shaft 15. The base 20 is located between the support walls 10 and 11. A housing 22 is fixed on the base 20. As described above, The rotary stage 3 rotates as the stepping motor 4 is driven. This can rotate the base 20 about the axis P. In this manner, the stepping motor 4, the worm gear 5, the rotator 7, and the rotary stage 3 in the present embodiment serve as a first rotary driver that rotates the base 20 about the axis P (first base rotational axis).

A stepping motor 30 is located on the rotary stage 3. A gear 31 is attached to the rotational shaft of the stepping motor 30. The gear 31 meshes with the gear 21 in the double gear. A gear 16 is attached to the shaft 15. The gear 16 meshes with the gear 23 in the double gear. The shaft 15 and the base 20 thus rotate about an axis Q through the gear 31, the double gear (gears 21 and 23), and the gear 16 as the stepping motor 30 is driven. In this manner, the stepping motor 30, the gear 31, the double gear (gears 21 and 23), and the gear 16 in the present embodiment serve as a second rotary driver that rotates the base 20 about the axis Q (second base rotational axis).

FIG. 3 is a schematic partial cross-sectional plan view of the housing 22, showing its internal structure. As shown in FIG. 3, the housing 22 accommodates an imaging unit 24 including a lens and an image sensor. The imaging unit 24 is connected to the housing 22 with a connector 26.

The connector 26 is, for example, a gimbal frame. The connector 26 connects the imaging unit 24 to the housing 22 in a rotatable manner about one or more unit rotational axes in the housing 22. The connector 26 in the present embodiment includes a connection frame 27, a first bearing 28A connecting the connection frame 27 to the housing 22 in a rotatable manner about a first unit rotational axis (e.g., X-axis), and a second bearing 28B connecting the imaging unit 24 to the connection frame 27 in a rotatable manner about a second unit rotational axis (e.g., Z-axis). The first unit rotational axis and the second unit rotational axis may be orthogonal to each other. The connector 26 supports the imaging unit 24 in a rotatable manner about the first unit rotational axis, the second unit rotational axis, or both the axes in the housing 22. Although the second bearing 28B is shown in FIG. 3 for simplicity, the actual second bearing 28B is located at a position different from the position shown in FIG. 3.

The imaging unit 24 includes a first drive 42 that moves the imaging unit 24 in a first drive direction (e.g., Y-direction) in the housing 22. The first drive 42 is, for example, a voice coil motor. The first drive 42 includes a yoke 51 and a magnet 52 on a side surface of the imaging unit 24, and a coil 53 in the housing 22. The magnet 52 has magnetic poles different from each other, for example, in the Y-direction. The coil 53 is located at a position facing the yoke 51 and the magnet 52. A magnetic sensor 58 is located inside the coil 53 to detect a change in the magnetic field produced by the magnet 52. An output from the magnetic sensor 58 is used to detect a position (posture) of the imaging unit 24. Such a magnetic sensor may be, for example, a Hall device using the Hall effect or a magneto resistive sensor (MR sensor) using magnetoresistance.

In addition to the above first drive 42, the imaging device 1 includes a second drive (not shown) that moves the imaging unit 24 in a second drive direction (e.g., Y-direction). The second drive has the same structure as the first drive 42 and is located on, for example, a side surface of the imaging unit 24 adjacent to the side surface on which the first drive 42 is located. The same magnetic sensor as the magnetic sensor 58 described above is also located in a coil in the second drive.

In response to the coil 53 in the first drive 42 being energized, the imaging unit 24 receives a force in the first drive direction from a magnetic field produced by the coil 53 and from the magnet 52. Similarly, in response to the coil in the second drive being energized, the imaging unit 24 receives a force in the second drive direction from a magnetic field produced by the coil and from a magnet. In the present embodiment, the imaging unit 24 is supported by the connector 26 in a rotatable manner about the first unit rotational axis and the second unit rotational axis. The first drive 42 and the second drive are driven to apply a force to the imaging unit 24. This can rotate the imaging unit 24 about the first unit rotational axis and the second unit rotational axis.

As shown in FIG. 1, a first sensor 60 is located on the base 20 to detect the acceleration or the angular velocity of the base 20. As shown in FIG. 3, a second sensor 62 is located in the imaging unit 24 to detect the acceleration or the angular velocity of the imaging unit 24. The sensors 60 and 62 may each be, for example, an acceleration sensor that detects the acceleration or a gyro sensor that detects the angular velocity.

As shown in FIG. 1, the imaging device 1 includes a controller 70 that controls the operations of the stepping motors 4 and 30, the first drive 42, and the second drive described above. The controller 70 is connected to the stepping motors 4 and 30, the first drive 42, the second drive, the magnetic sensor 58 in the first drive 42, the magnetic sensor in the second drive, and the sensors 60 and 62.

The controller 70 drives the stepping motor 4 to rotate the rotary stage 3 about the axis P. This allows the imaging unit 24 on the base 20 to pan. The controller 70 drives the stepping motor 30 to rotate the shaft 15 about the axis Q. This allows the imaging unit 24 on the base 20 to tilt.

When performing panning or tilting (in other words, changing the orientation of the imaging unit 24), the controller 70 controls, in response to output signals from the sensors 60 and 62, energization of the coils in the first drive 42 and the second drive based on the acceleration or the angular velocity of the imaging unit 24 to rotate the imaging unit 24 about the first unit rotational axis, the second unit rotational axis, or both the axes relative to the housing 22. This counteracts any displacement of the imaging unit 24 in the housing 22 resulting from panning or tilting. In this manner, images captured by the imaging unit 24 are less likely to be blurred.

The controller 70 may detect the position (posture) of the imaging unit 24 in response to output signals from the magnetic sensor 58 (third sensor) in the first drive 42 and the magnetic sensor (third sensor) in the second drive. The controller 70 may control the first drive 42 and the second drive based on the current posture of the imaging unit 24. The movement of the imaging unit 24 can thus be controlled more precisely to more effectively reduce the likelihood of images being blurred.

The imaging device 1 according to the present embodiment includes the two rotary drivers to rotate the base 20. In some embodiments, the imaging device 1 may include either of the two rotary drivers alone. The sensor 62 may be eliminated. The first drive 42 and the second drive may be controlled based on the acceleration or the angular velocity of the base 20 detected by the sensor 60.

When the two rotary drivers rotate the base 20 about the two base rotational axes as in the present embodiment, the imaging unit 24 is to be supported by the connector 26 in a rotatable manner about the two unit rotational axes to counteract any displacement of the imaging unit 24 resulting from rotations about the base rotational axes. In this case, the two base rotational axes may not be parallel to the two unit rotational axes. In contrast, when the imaging device 1 includes a single rotary driver and the imaging unit 24 is supported by the connector 26 in a rotatable manner about a single unit rotational axis, the base rotational axis of the rotary driver may be parallel to the unit rotational axis to effectively reduce the likelihood of images being blurred.

As described above, the imaging device according to one or more embodiments of the present invention may have the structures described below.

### First Structure

An imaging device, comprising:
a base;
a housing fixed on the base;
a first rotary driver configured to rotate the base about a first base rotational axis;
an imaging unit accommodated in the housing, the imaging unit including an image sensor;
a connector connecting the imaging unit to the housing to allow the imaging unit to rotate about at least a first unit rotational axis in the housing; and
a drive configured to move the imaging unit in the housing.

### Second Structure

The imaging device according to the first structure, further comprising:
a first sensor configured to detect an acceleration or an angular velocity of the base; and
a controller configured to control an operation of the drive based on an output from the first sensor.

### Third Structure

The imaging device according to the second structure, further comprising:
a second sensor configured to detect an acceleration or an angular velocity of the imaging unit,
wherein the controller controls the operation of the drive based on outputs from the first sensor and the second sensor.

### Fourth Structure

The imaging device according to the third structure, further comprising:
a third sensor configured to detect a position of the imaging unit relative to the housing,
wherein the controller controls the operation of the drive based on outputs from the first sensor, the second sensor, and the third sensor.

### Fifth Structure

The imaging device according to any one of the first to fourth structures, further comprising:
a second rotary driver configured to rotate the base about a second base rotational axis different from the first base rotational axis.

### Sixth Structure

The imaging device according to any one of the first to fifth structures, wherein
the connector allows the imaging unit to rotate about a second unit rotational axis in the housing, and the second unit rotational axis is orthogonal to the first unit rotational axis.

### Seventh Structure

The imaging device according to any one of the first to sixth structures, wherein the first base rotational axis is parallel to the first unit rotational axis.

Although one or more embodiments of the present invention have been described above, the present invention is not limited to the above embodiments and may be modified variously within the scope of its technical idea.

What is claimed is:

1. An imaging device, comprising:
a base;
a housing fixed on the base;
a first rotary driver configured to rotate the base about a first base rotational axis;
an imaging unit accommodated in the housing, the imaging unit including an image sensor;
a connector connecting the imaging unit to the housing to allow the imaging unit to rotate about at least a first unit rotational axis in the housing; and
a drive configured to move the imaging unit in the housing.

2. The imaging device according to claim 1, further comprising:
a first sensor configured to detect an acceleration or an angular velocity of the base; and
a controller configured to control an operation of the drive based on an output from the first sensor.

3. The imaging device according to claim 2, further comprising:
a second sensor configured to detect an acceleration or an angular velocity of the imaging unit,
wherein the controller controls the operation of the drive based on outputs from the first sensor and the second sensor.

4. The imaging device according to claim 3, further comprising:
a third sensor configured to detect a position of the imaging unit relative to the housing,
wherein the controller controls the operation of the drive based on outputs from the first sensor, the second sensor, and the third sensor.

5. The imaging device according to claim 1, further comprising:
a second rotary driver configured to rotate the base about a second base rotational axis different from the first base rotational axis.

6. The imaging device according to claim 1, wherein
the connector allows the imaging unit to rotate about a second unit rotational axis in the housing, and the second unit rotational axis is orthogonal to the first unit rotational axis.

7. The imaging device according to claim 1, wherein
the first base rotational axis is parallel to the first unit rotational axis.
